(19) United States
(12) Patent Application Publication
(10) Pub. No.: US 2024/0323038 A1
(43) Pub. Date: Sep. 26, 2024

(54) METHOD OF UPLOADING AND MANAGING SINGLE DATA SET LARGER THAN MAXIMUM BLOCK SIZE ON BLOCKCHAIN

(71) Applicant: ARTIFRIENDS INC., Seongnam-si, Gyeonggi-do (KR)

(72) Inventor: Jung Woo LEE, Daejeon (KR)

(73) Assignee: ARTIFRIENDS INC., Seongnam-si, Gyeonggi-do (KR)

(21) Appl. No.: 18/575,469

(22) PCT Filed: Jun. 23, 2022
(86) PCT No.: PCT/KR2022/008908

§ 371 Date: Dec. 29, 2023

(30) Foreign Application Priority Data
Jun. 30, 2021 (KR) 10-2021-0085986
Jun. 21, 2022 (KR) 10-2022-0075846

(51) Int. Cl. H04L 9/00; G06F 21/62; H04L 67/5682

(52) U.S. Cl. CPC H04L 9/50; G06F 21/62; H04L 67/5682

(57) ABSTRACT

A method of uploading and managing a single data set larger than a maximum block size on a blockchain includes making a request to upload any data to the blockchain through a blockchain service, determining whether the data requested to be uploaded is larger than the maximum block size, defining any abstract storage space as one blockchain when the data requested to be uploaded is large-scale data larger than the maximum block size, dividing the large-scale data into a plurality of separate data sets and storing the plurality of separate data sets separately in the abstract storage space, making a request to download the large-scale data stored in a divided manner in the abstract storage space through the blockchain service, downloading the plurality of separate data sets separately stored in the abstract storage space and restoring the large-scale data, and providing the restored large-scale data to a user terminal.

### BACKGROUND OF THE INVENTION

### Field of the Invention

The present disclosure relates to a method of uploading and managing a single data set on a blockchain. More particularly, the present disclosure relates to a method of uploading and managing a single data set larger than the maximum block size on a blockchain, the method being capable of uploading and managing large-scale data on a blockchain without loss.

### Description of the Related Art

Concerning speed and expansion in a blockchain network based on Bitcoin, the first-generation blockchain technology, and Ethereum, the second-generation blockchain technology, among commonly known blockchains, users at the initial stage of Bitcoin were not as many as they are today, so 10 minutes were enough to put all transaction details in one block. However, as Bitcoin became known to the public, the number of transactions that had to be processed increased, and as a result, it became impossible to put all generated transaction details in one block for 10 minutes. Bitcoin processes about 3 to 7 transactions per second, Ethereum processes about 20 transactions per second. This is a very low speed compared to existing representative payment methods, such as PayPal (processing about 200 transactions per second) and Visa Card (processing about 2,000 transactions per second).

Herein, problems with speed and expandability of Bitcoin and Ethereum in the related art will be described.

First, regarding speed, an indicator of speed in a blockchain is transactions per second (TPS), which means the number of transactions that can be processed per second. For example, one million TPS means the speed at which one million transactions can be processed per second. In the case of Bitcoin, considering a 1-MB block capacity limit and block generation speed of 10 minutes, the speed for one transaction is calculated to be less than about 7 TPS. Since a limit to which transactions can be processed is determined from the beginning by design, there is no choice but to reduce the transaction size or to increase block generation speed in order to further improve performance. In addition, in the case of Ethereum, a block generation period is about 12 seconds, and TPS is about 10 to 30. Unlike Bitcoin, a block size and a transaction size are not determined. The mining speed is much faster than that of Bitcoin, but TBS processing is not smooth because the gas that can be used per block is determined, thus causing a slowdown in speed.

Second, regarding expandability, Bitcoin has blocks each having the size of 1 MB. However, the 1-MB block size is insufficient for the number of transactions that Bitcoin has to process. In addition, in order to transact with Bitcoin, a particular fee must be paid to a miner. If this fee is low, transaction speed may be significantly delayed. This is because miners give priority to high fees when transaction details are stored in blocks.

Unlike Bitcoin, Ethereum, another blockchain technology, has a speed delay problem because of a limit to the size of gas that can be contained in one block rather than the block size. Herein, the gas can be regarded as a concept of transaction fees occurring on the Ethereum platform, and one Ethereum block is limited to about 6.7 million gas.

As described above, Bitcoin, the first-generation existing blockchain technology, has a problem with the capacity size of a 1-MB block itself. Unlike Bitcoin, in Ethereum, the second-generation existing blockchain technology, a block size and a transaction size are not determined, but the gas for processing these is determined, so it is difficult to improve speed and expansion.

In the meantime, Korean Patent Application Publication No. 10-2019-0132938 (Patent Document 1) discloses “METHOD AND APPARATUS FOR MANAGING SUBJECT DATA BASED ON BLOCKCHAIN”. According to this, a blockchain-based subject data management method includes: creating subject data in accordance with a request of a user device; creating first metadata related to the subject data; creating a first block including the created first metadata to store the first block in a blockchain included in a subject data management apparatus; creating first code information based on information included in the first block; and storing the created first code information and the subject data in a database, wherein the first code information is used as address information of the database in which the subject data is stored.

In the case of Patent Document 1, a centralized database and a blockchain technology are complementarily used for data storage and management, and integrity, confidentiality, and availability of data can be guaranteed. However, because of the mechanism in which the first metadata related to the subject data is created, the first block including the first meta data is created, and the first block is stored in the blockchain included in the subject data management apparatus, the process until any subject data is stored in a blockchain is complicated and there is no solution to the problem with uploading a single data set larger than the maximum block size on a blockchain, to the blockchain.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is created considering the fact that it is difficult to upload and manage a single large data set because of problems with speed and expansion of the conventional blockchain. The present disclosure is directed to providing a method of uploading and managing a single data set larger than the maximum block size on a blockchain, the method being capable of uploading and managing large-scale data on the blockchain without loss by proposing a solution for uploading the single data set larger than the maximum block size on the blockchain.

According to the present disclosure, there is provided a method of uploading and managing a single data set larger than the maximum block size on a blockchain, the method including:
a) making, by a user terminal, a request to upload any data to the blockchain through a blockchain service;
b) determining, by a blockchain service server in response to the request for uploading, whether the data requested to be uploaded is larger than the maximum block size;
c) defining, by the blockchain service server, any abstract storage space as one blockchain when it is determined that the data requested to be uploaded is large-scale data larger than the maximum block size;
d) dividing, by the blockchain service server, the large-scale data into a plurality of separate data sets and storing the plurality of separate data sets separately in the abstract storage space;
e) making, by the user terminal or a different user terminal, a request to download the large-scale data stored in a divided manner in the abstract storage space through the blockchain service;
f) downloading, by the blockchain service server in response to the request for downloading, the plurality of separate data sets separately stored in the abstract storage space and combining the plurality of separate data sets into one single data set to restore the large-scale data; and
g) providing, by the blockchain service server, the restored large-scale data to the user terminal or the different user terminal that has made the request for downloading.

Herein, in the step b), the blockchain service server may provide a SASEUL-based blockchain service.

Herein, the SASEUL-based blockchain service may include a non-fungible token (NFT) market service.

In addition, in the step c) of defining the any abstract storage space as the one blockchain by the blockchain service server, the any abstract storage space may be defined as the one blockchain by using a smart contract.

In addition, in the step c), the abstract storage space may be provided in a SASEUL network that provides network resources and functions required for the blockchain service.

In addition, in the step d) of dividing the large-scale data into the plurality of separate data sets by the blockchain service server, the large-scale data may be divided into the plurality of separate data sets over multiple transactions.

In addition, in the step d) of dividing the large-scale data into the plurality of separate data sets and storing the plurality of separate data sets separately in the abstract storage space, a contract or a status may be stored.

According to the present disclosure, an abstract storage space is defined, large-scale data is divided into multiple data sets over several transactions, and the multiple data sets are stored in the abstract storage space, whereby a single data set larger than the maximum block size is uploaded and managed on the blockchain, which was impossible in a conventional blockchain system.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram showing a block structure of Bitcoin in a conventional blockchain;

FIG. 2 is a diagram showing a block validation algorithm structure of Ethereum in a conventional blockchain;

FIG. 3 is a flowchart showing a method of uploading and managing a single data set larger than the maximum block size on a blockchain according to the present disclosure;

FIG. 4 is a diagram showing a process of uploading a single data set larger than the maximum block size to a SASEUL blockchain;

FIG. 5 is a diagram showing an outline of dividing large-scale data and storing a result of division in an abstract storage space; and

FIG. 6 is a diagram showing an outline of a rule for dividing large-scale data for divided storage of the large-scale data.

### DETAILED DESCRIPTION OF THE INVENTION

The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the best method he or she knows for carrying out the disclosure.

Throughout the specification, when a part “includes” an element, it is noted that it further includes other elements, but does not exclude other elements, unless specifically stated otherwise. Also, the terms “ . . . part”, “ . . . unit”, “module”, “device”, and the like mean a unit for processing at least one function or operation and may be implemented by hardware, software, or a combination of hardware and software.

Hereinafter, an embodiment of the present disclosure will be described with reference to the accompanying drawings.

Here, before describing the embodiment of the present disclosure, Bitcoin and Ethereum structures in a blockchain applied to the present disclosure will be described first to help the understanding of the present disclosure.

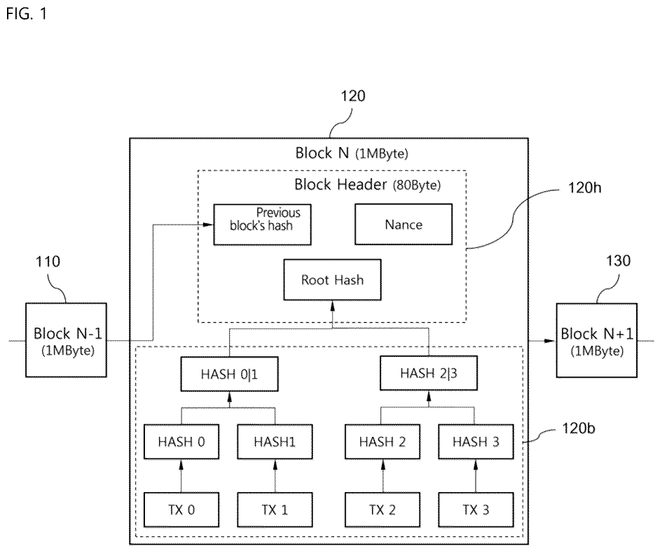

FIG. 1 is a diagram showing a block structure of Bitcoin in a conventional blockchain.

Referring to FIG. 1, each of the blocks 110, 120, and 130 of Bitcoin in the related art schematically includes a block header 120h and a block body 120b. The block header 120h is a part in which information on a block is stored when the block is generated. The previous block's hash in the block header 120h connects a block to a block. When the block header 120h derives a hash value, a number, called nance, is appended to the hash value. That is, when a hash value lower than a target hash value is derived, the number appended to the hash value of the block header 120h is a “nance” and the value of the nance is the answer of the block. A “root hash” refers to a process of deriving one hash value by pairing transactions TX 0 to TX 3 stored in the block.

The block body 120b is a part in which transaction information of Bitcoin and a transaction TX are stored. Transaction records are denoted by TX 0 to TX 3. Results of applying an SHA-256 hash function after pairing the transaction records are denoted by HASH 0 to HASH 3. A result of applying the SHA-256 hash function once more to the result of applying the hash function in the previous step is denoted by HASH 0|1.

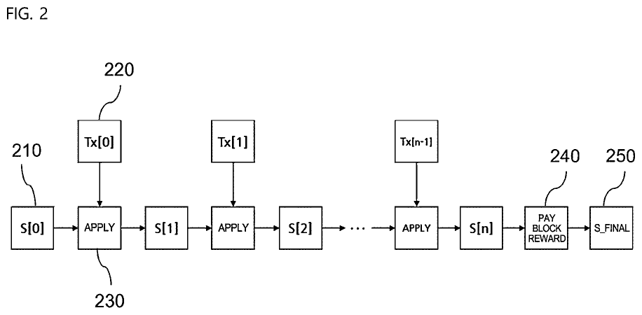

FIG. 2 is a diagram showing a block validation algorithm structure of Ethereum in a conventional blockchain.

Referring to FIG. 2, the last status of the previous block is denoted by S[0] to S[n] 210. A list of n transactions of the current block is denoted by Tx[0] to Tx[n−1] 220. The word APPLY 230 means that validation is completed and proceeding to the next status takes place. The expression “PAY BLOCK REWARD” 240 refers to a reward block paid to a miner. The expression S_FINAL 250 means that S[n] to which the reward block is appended is assumed to be Final S[n].

In the block validation algorithm of Ethereum as described above, in order to create a new block, transaction data 0 (Tx[0]) to transaction data n (Tx[n]) are applied to respective accounts (addresses) and a change in the balance of each account is recorded. Finally, S_FINAL for all the accounts including the transaction details is transmitted to a network.

Hereinafter, an embodiment of the present disclosure will be described.

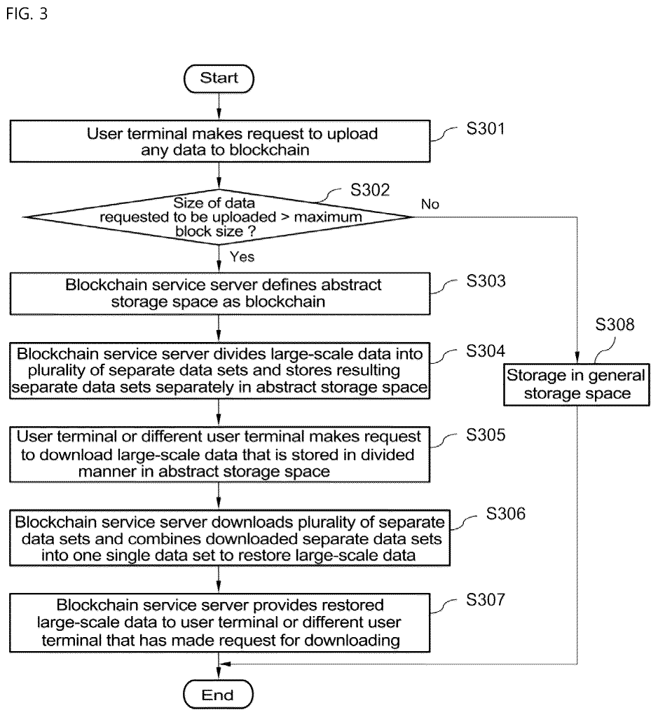

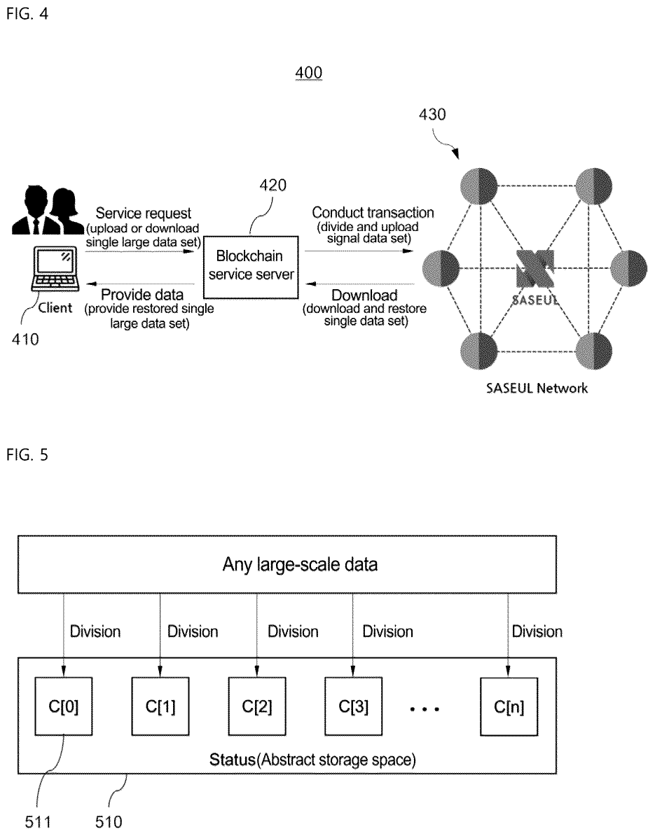

FIG. 3 is a flowchart showing a method of uploading and managing a single data set larger than the maximum block size on a blockchain according to the present disclosure. FIG. 4 is a diagram showing a process of uploading a single data set larger than the maximum block size to a SASEUL blockchain.

Referring to FIGS. 3 and 4, the method of uploading and managing a single data set larger than the maximum block size on a blockchain according to the present disclosure is based on a system 400 for uploading and managing the single data set on the blockchain. The system 400 includes: a user terminal 410 requesting a blockchain service; a blockchain service server 420 providing the service in response to the request for the service from the user terminal 410; and a SASEUL network 430 of the blockchain in which data is stored in a divided manner. In the method, when the user terminal 410 makes a request to upload any data to the blockchain through the blockchain service in step S301, the blockchain service server 420 determines whether the data requested to be uploaded is larger than the maximum block size in step S302, in response to the request for uploading. Herein, the blockchain service server 420 may provide a SASEUL-based blockchain service. The SASEUL-based blockchain service may include a non-fungible token (NFT) market service. Herein, the NFT is a “non-fungible token” that is based on a blockchain and has uniqueness and scarcity because exchange and replication are impossible. Such NFTs are digital tokens to which a blockchain technology is applied. Each token is given a unique recognition value and thus has an irreplaceable value and characteristics, making exchange and replication impossible.

When it is determined in step S302 that the data requested to be uploaded is large-scale data larger than the maximum block size, the blockchain service server 420 defines any abstract storage space (the abstract storage space is called “Status” in the present disclosure) as one blockchain in step S303. Herein, in defining the any abstract storage space as the one blockchain by the blockchain service server 420, the any abstract storage space may be defined as the one blockchain by using a smart contract. Furthermore, the abstract storage space may be provided in the SASEUL network 430 that provides network resources and functions required for the blockchain service. Furthermore, the abstract storage space, that is, a storage space called Status (see FIG. 5), means a space in which only a status value of a block is stored. The reason why the space is expressed as the “abstract storage space” is that because of the nature of a blockchain, the space can be found through the device (e.g., a PC) to which a user is currently connected, but intact original data may not exist in the device and is divided and relatively viewed and found.

In this way, when the defining of the abstract storage space as one blockchain is completed, the blockchain service server 420 divides the large-scale data into a plurality of separate data sets 511 C[0] to C[n] and stores the plurality of separate data sets 511 C[0] to C[n] separately in the abstract storage space (Status) 510 in step S304, as shown in FIG. 5. Herein, in dividing the large-scale data into the plurality of separate data sets C[0] to C[n] by the blockchain service server 420, the large-scale data may be divided into the plurality of separate data sets over multiple transactions.

Furthermore, in dividing the large-scale data into the plurality of separate data sets C[0] to C[n] and storing the plurality of separate data sets C[0] to C[n] separately in the abstract storage space 510, a contract or a status may be stored. Hereinafter, the division of the large-scale data as described above will be described in more detail.

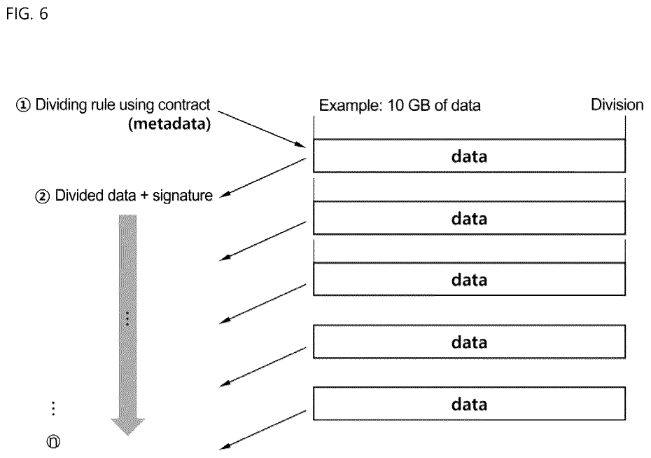

For example, as shown in FIG. 6, assuming that there is 10 GB of data, when the data is intended to be stored in the blockchain, it is necessary to give a signature to the entire data in order to prevent forgery and falsification of the data. However, as of now, there is very little in the way of giving a signature to 10 GB of data and checking.

A dividing rule using a contract is considered as one meta data set, and the data divided into Number 2 to n are stored in the blockchain. Herein, the dividing rule for the subsequent numbers is defined as a contract at Number 1, and the data sets are stored. Herein, a signature is divided to prevent forgery and falsification of the 10 GB of data. The rule used to divide the signature is put into the contract as it is. Even if sub-data is wrong, the dividing rule is known, and when original data is received, it is consequently easy to verify forgery and falsification of data by only using the original data the dividing rule. This is because the contract can be changed (forgery and falsification), but it is impossible to forge or falsify the dividing rule.

After the single large data set larger than the maximum block size is stored, the user terminal 410 or a different user terminal makes a request to download the large-scale data that is stored in a divided manner in the abstract storage space 510 through the blockchain service in step S305, and in response to the request for downloading, the blockchain service server 420 downloads the plurality of separate data sets separately stored in the abstract storage space 510 and combines the plurality of separate data sets into one single data set to restore the large-scale data in step S306.

Afterward, the blockchain service server 420 provides the restored large-scale data to the user terminal 410 or the different user terminal that has made the request for downloading, in step S307.

In the meantime, when it is determined in step S302 that the data requested to be uploaded is not larger than the maximum block size, the blockchain service server 420 stores the data requested to be uploaded, in a general storage space for storing normal size data, in step S308.

As described above, according to a method of uploading and managing a single data set larger than the maximum block size on a blockchain according to the present disclosure, an abstract storage space is defined, large-scale data is divided into multiple data sets over several transactions, and the multiple data sets are stored in the abstract storage space, whereby a single data set larger than the maximum block size is uploaded and managed on the blockchain, which was impossible in a conventional blockchain system.

Although an exemplary embodiment of the present disclosure has been described in detail, the present disclosure is not limited thereto, and it is obvious to those skilled in the art that various modification and applications can be made within the scope of the technical idea of the present disclosure. Accordingly, the true scope of the present disclosure should be interpreted by the following claims, and all technical ideas within the scope equivalent thereto should be interpreted as being included in the scope of the present disclosure.

What is claimed is:

1. A method of uploading and managing a single data set larger than a maximum block size on a blockchain, the method comprising:
a) making, by a user terminal, a request to upload any data to the blockchain through a blockchain service;
b) determining, by a blockchain service server in response to the request for uploading, whether the data requested to be uploaded is larger than the maximum block size;
c) defining, by the blockchain service server, any abstract storage space as one blockchain when it is determined that the data requested to be uploaded is large-scale data larger than the maximum block size;
d) dividing, by the blockchain service server, the large-scale data into a plurality of separate data sets and storing the plurality of separate data sets separately in the abstract storage space;
e) making, by the user terminal or a different user terminal, a request to download the large-scale data stored in a divided manner in the abstract storage space through the blockchain service;
f) downloading, by the blockchain service server in response to the request for downloading, the plurality of separate data sets separately stored in the abstract storage space and combining the plurality of separate data sets into one single data set to restore the large-scale data; and
g) providing, by the blockchain service server, the restored large-scale data to the user terminal or the different user terminal that has made the request for downloading.

2. The method of claim 1, wherein in the step b), the blockchain service server provides a SASEUL-based blockchain service.

3. The method of claim 2, wherein the SASEUL-based blockchain service includes a non-fungible token (NFT) market service.

4. The method of claim 1, wherein in the step c) of defining the any abstract storage space as the one blockchain by the blockchain service server, the any abstract storage space is defined as the one blockchain by using a smart contract.

5. The method of claim 1, wherein in the step c), the abstract storage space is provided in a SASEUL network that provides network resources and functions required for the blockchain service.

6. The method of claim 1, wherein in the step d) of dividing the large-scale data into the plurality of separate data sets by the blockchain service server, the large-scale data is divided into the plurality of separate data sets over multiple transactions.

7. The method of claim 1, wherein in the step d) of dividing the large-scale data into the plurality of separate data sets and storing the plurality of separate data sets separately in the abstract storage space, a contract or a status is stored.
